(19) United States
(12) Patent Application Publication
(10) Pub. No.: US 2017/0187024 A1
(43) Pub. Date: Jun. 29, 2017

(54) SEPARATOR FOR RECHARGEABLE BATTERY AND RECHARGEABLE BATTERY INCLUDING THE SAME

(71) Applicant: SAMSUNG SDI CO., LTD., Yongin-si (KR)

(72) Inventors: Keewook KIM, Suwon-si (KR); Jinkyu PARK, Suwon-si (KR); Hyeonsun CHOI, Suwon-si (KR)

(21) Appl. No.: 15/379,551

(22) Filed: Dec. 15, 2016

(30) Foreign Application Priority Data
Dec. 23, 2015 (KR) 10-2015-0185215

(51) Int. Cl. H01M 2/16; C08K 3/22; C08J 9/28; C08J 9/00; H01M 10/0525; C08F 251/02

(52) U.S. Cl. CPC H01M 2/1686; H01M 2/166; H01M 10/0525; C08F 251/02; C08J 9/28; C08J 9/0066; C08K 3/22; H01M 2220/20; C08J 2201/0502; C08J 2351/02; C08K 2003/2227

(57) ABSTRACT

A separator for a rechargeable battery and a rechargeable lithium battery, the separator including a porous substrate; and a heat-resistant porous layer on at least one surface of the porous substrate, wherein the heat-resistant porous layer includes a filler and a copolymer including a structural unit of vinylidenefluoride, a structural unit of hexafluoropropylene, and a structural unit of a carboxyl-containing monomer, the structural unit of hexafluoropropylene is present in an amount of about 4 wt % to about 10 wt %, based on a total weight of the copolymer, and the structural unit of a carboxyl-containing monomer is present in an amount of about 1 wt % to about 7 wt %, based on the total weight of the copolymer.

### CROSS-REFERENCE TO RELATED APPLICATION

Korean Patent Application No. 10-2015-0185215, filed on Dec. 23, 2015, in the Korean Intellectual Property Office, and entitled: “Separator for Rechargeable Battery and Rechargeable Battery Including the Same,” is incorporated by reference herein in its entirety.

### BACKGROUND

1. Field

Embodiments relate to a separator for a rechargeable battery and a rechargeable lithium battery including the same.

2. Description of the Related Art

A separator for an electrochemical battery is an intermediate film that separates a positive electrode and a negative electrode in a battery, and maintains ion conductivity continuously to enable charge and discharge of a battery.

### SUMMARY

Embodiments are directed to a separator for a rechargeable battery and a rechargeable lithium battery including the same.

The embodiments may be realized by providing a separator for a rechargeable battery, the separator including a porous substrate; and a heat-resistant porous layer on at least one surface of the porous substrate, wherein the heat-resistant porous layer includes a filler and a copolymer including a structural unit of vinylidenefluoride, a structural unit of hexafluoropropylene, and a structural unit of a carboxyl-containing monomer, the structural unit of hexafluoropropylene is present in an amount of about 4 wt % to about 10 wt %, based on a total weight of the copolymer, and the structural unit of a carboxyl-containing monomer is present in an amount of about 1 wt % to about 7 wt %, based on the total weight of the copolymer.

The copolymer may include the structural unit of hexafluoropropylene and the structural unit of the carboxyl-containing monomer in a weight ratio of about 1:1 to about 4:1.

The carboxyl-containing monomer may include a substituted or unsubstituted (meth)acrylic acid, a substituted or unsubstituted (meth)acryloyloxy acetic acid, a substituted or unsubstituted (meth)acryloyloxy alkyl acid, a substituted or unsubstituted itaconic acid, a substituted or unsubstituted maleic acid, a substituted or unsubstituted maleic anhydride, or a combination thereof.

The copolymer may have a weight average molecular weight of about 800,000 g/mol to about 1,500,000 g/mol.

The filler may be included in an amount of about 50 wt % to about 99 wt %, based on a total weight of the copolymer and the filler.

The filler may include Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, or a combination thereof.

The porous substrate may include a polyolefin.

The porous substrate may be in the form of a single layer or two or more layers.

The embodiments may be realized by providing a rechargeable lithium battery including a positive electrode, a negative electrode, and the separator according to an embodiment between the positive electrode and the negative electrode.

### BRIEF DESCRIPTION OF THE DRAWINGS

Features will be apparent to those of skill in the art by describing in detail exemplary embodiments with reference to the attached drawings in which:

FIG. 1 illustrates a schematic view sectional view of a separator for a rechargeable battery according to an embodiment, and

FIG. 2 illustrates a perspective view of a rechargeable lithium battery according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. Further, it will be understood that when a layer is referred to as being “under” another layer, it can be directly under, and one or more intervening layers may also be present. Like reference numerals refer to like elements throughout.

Hereinafter, a separator for a rechargeable battery according to an embodiment is described.

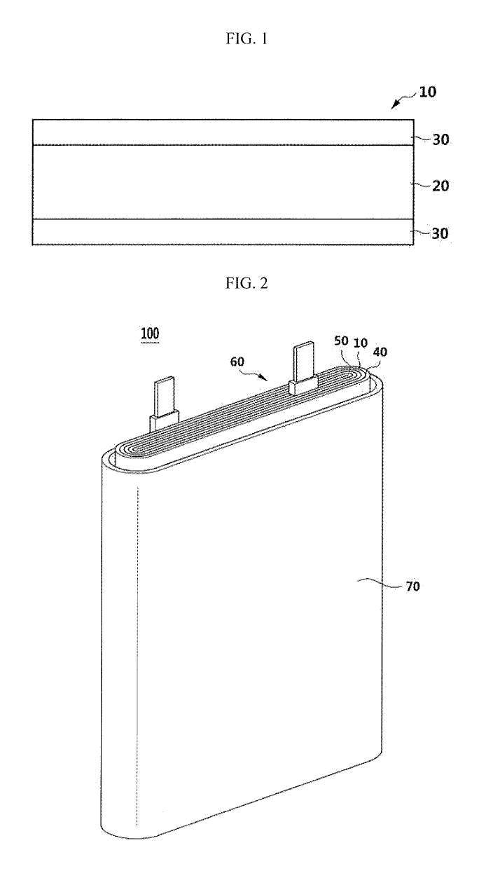

FIG. 1 illustrates a schematic sectional view of a separator for a rechargeable battery according to an embodiment.

Referring to FIG. 1, a separator 10 for a rechargeable battery according to an embodiment may include a porous substrate 20 and a heat-resistant porous layer 30 on one surface or both surfaces of the porous substrate 20.

The porous substrate 20 may have a plurality of pores and may be a porous substrate suitable for use in an electrochemical device. Examples of the porous substrate 20 may include a polymer film formed of a polymer or a mixture of two or more of polyolefin such as polyethylene and polypropylene; polyester such as polyethyleneterephthalate and polybutyleneterephthalate; polyacetal, polyamide, polyimide, polycarbonate, polyetheretherketone, polyaryletherketone, polyetherimide, polyamideimide, polybenzimidazole, polyethersulfone, polyphenyleneoxide, a cyclic olefin copolymer, polyphenylenesulfide, polyethylenenaphthalate, a glass fiber, tetrafluoroethylene (TEFLON), and polytetrafluoroethylene (PTFE). For example, the porous substrate 20 may be a polyolefin substrate, and the polyolefin substrate may help improve safety of a battery due to its improved shut-down function. The polyolefin substrate may be, e.g., selected from a polyethylene single film, a polypropylene single film, a polyethylene/polypropylene double film, a polypropylene/polyethylene/polypropylene triple film, and a polyethylene/polypropylene/polyethylene triple film. The polyolefin resin may include a non-olefin in addition to an olefin or a copolymer of olefin and a non-olefin.

The porous substrate 20 may have a thickness of about 1 μm to about 40 μm, e.g., about 1 μm to about 30 μm, about 1 μm to about 20 μm, about 5 μm to about 15 μm, or about 5 μm to about 10 μm.

The heat-resistant porous layer 30 may include, e.g., a filler and a binder.

The filler may be, e.g., an inorganic filler, an organic filler, an organic/inorganic filler, or a combination thereof. The inorganic filler may be a ceramic material capable of improving heat resistance, e.g., a metal oxide, a semi-metal oxide, a metal fluoride, a metal hydroxide, or a combination thereof. The inorganic filler may include, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂ or combination thereof. The organic filler may include, e.g., an acrylic compound, an imide compound, an amide compound, or a combination thereof. In an implementation, the organic filler may have a core-sell structure.

In an implementation, the filler may have a spherical shape or sheet shape having a size of about 1 nm to about 2,000 nm, e.g., about 100 nm to about 1,000 nm or about 100 nm to about 500 nm. Herein, the size is an average particle diameter or a longest diameter. When the filler has a size within the range, the heat-resistant layer 30 may have a desirable strength. The filler may be used by mixing two or more different kinds of fillers or two or more fillers having different sizes. The filler may help improve heat resistance and thus may help prevent a separator from being sharply contracted or transformed as a temperature is increased.

The binder may play a role of fixing the filler on the porous substrate 20 and simultaneously, may adhere the porous substrate 20 on one surface of the heat-resistant porous layer 30 and an electrode on the other surface thereof.

In an implementation, the binder may be, e.g., a copolymer obtained from a vinylidene fluoride, a hexafluoropropylene, and a monomer including at least one carboxyl group (hereinafter, referred to as ‘carboxyl-containing monomer’).

The copolymer may include a structural unit derived from or of vinylidenefluoride, a structural unit derived from or of hexafluoropropylene, and a structural unit derived from or of a carboxyl-containing monomer. In an implementation, a ratio of the structural unit of vinylidenefluoride, the structural unit of hexafluoropropylene, and the structural unit of a carboxyl-containing monomer may be substantially the same as a supply ratio of the vinylidenefluoride, the hexafluoropropylene, and the carboxyl-containing monomer.

In an implementation, the carboxyl-containing monomer may include, e.g., a (meth)acrylic acid or a derivative thereof (e.g., a substituted or unsubstituted (meth)acrylic acid), a (meth)acryloyloxy acetic acid or a derivative thereof (e.g., a substituted or unsubstituted (meth)acryloyloxy acetic acid), a (meth)acryloyloxyalkyl acid or a derivative thereof (e.g., a substituted or unsubstituted (meth)acryloyloxyalkyl acid), itaconic acid or a derivative thereof (e.g., a substituted or unsubstituted itaconic acid), maleic acid or a derivative thereof (e.g., a substituted or unsubstituted maleic acid), maleic anhydride or a derivative thereof (e.g., a substituted or unsubstituted maleic anhydride), or a combination thereof. For example, a substituted moiety may be one in which a hydrogen is replaced with another group.

In an implementation, the (meth)acrylic acid or a derivative thereof may include, e.g., acrylic acid, methacrylic acid, alkyl acrylate, alkyl methacrylate, hydroxyalkyl acrylate, hydroxyalkyl methacrylate, carboxylalkylacrylate, carboxylalkylmethacrylate, acryloyloxyalkylsuccinic acid, methacryloyloxyalkylsuccinic acid, acryloyloxyalkylphthalic acid, methacryloyloxyalkylphthalic acid, or a combination thereof. In an implementation, the (meth)acrylic acid or a derivative thereof may include, e.g., acrylic acid, methacrylic acid, hydroxyethylacrylate, hydroxyethylmethacrylate, carboxylethylacrylate, carboxylethylmethacrylate, acryloyloxyethylsuccinic acid, methacryloyloxyethylsuccinic acid, acryloyloxyethylphthalic acid, methacryloyloxyethylphthalic acid, or a combination thereof.

In an implementation, the (meth)acryloyloxy alkyl acid may include, e.g., 3-acryloyloxypropyl acid, 3-methacryloyloxypropyl acid, 4-acryloyloxybutyl acid, 4-methacryloyloxybutyl acid, or a combination thereof.

In an implementation, the maleic acid/maleic anhydride or a derivative thereof may include, e.g., maleic anhydride(2,5-furandione), 3-methyl-2,5-furandione, 3-ethyl-2,5-furandione, 3-propyl-2,5-furandione, 3-butyl-2,5-furandione, 3-pentyl-2,5-furandione, 3-hexyl-2,5-furandione, 3-heptyl-2,5-furandione, 3-octyl-2,5-furandione, or a combination thereof.

In an implementation, the copolymer may have a structure in which a structural unit derived from vinylidenefluoride is present as a main backbone, and a structural unit derived from hexafluoropropylene and a structural unit derived from a carboxyl-containing monomer are randomly distributed around the vinylidenefluoride main backbone. In an implementation, the copolymer may be an alternating polymer in which the structural units are alternately distributed, a random polymer in which the structural units are randomly distributed, or a graft polymer in which a part of the structural units are grafted, or the like.

In an implementation, the structural unit derived from hexafluoropropylene may be included in an amount of, e.g., about 4 wt % to about 10 wt %, based on a total weight of the copolymer. When the structural unit derived from hexafluoropropylene is included within the range, adherence to the heat-resistant porous layer 30 may not only be secured but solubility in a low boiling point solvent may also be improved. Accordingly, the heat-resistant porous layer 30 may be formed by using the low boiling point solvent without a separate additional process, and thus a high boiling point solvent (which may deteriorate permeability) may not be used. The low boiling point solvent may be, e.g., a solvent having a boiling point of less than or equal to about 80° C., such as acetone, methylethylketone, ethylisobutylketone, tetrahydrofuran, dimethylformaldehyde, cyclohexane, or a mixed solvent thereof. For example, the copolymer may have a solubility of less than or equal to about 20 in a solvent having a boiling point of less than or equal to about 80° C. at less than or equal to 40° C. In an implementation, the structural unit derived from hexafluoropropylene may be, e.g., included in an amount of about 5 to about 7 wt % based on the entire weight of the copolymer.

In an implementation, the structural unit derived from a carboxyl-containing monomer may be included in an amount of, e.g., about 1 wt % to about 7 wt %, based on the total weight of the copolymer. When the structural unit derived from a carboxyl-containing monomer is included within the range, adherence of the heat-resistant porous layer 30 to the porous substrate 20 and the electrode may be improved. In an implementation, the structural unit derived from a carboxyl-containing monomer may be, e.g., included in an amount of about 1.5 to about 5 wt %.

In an implementation, the structural unit derived from vinylidenefluoride may be included in a balance amount (e.g., except for the total amount of the structural unit derived from hexafluoropropylene and the structural unit derived from a carboxyl-containing monomer), e.g., in an amount of about 83 to about 95 wt %. In an implementation, the structural unit derived from vinylidenefluoride may be for example included in an amount of about 88 to about 93.5 wt %.

In an implementation, the structural unit derived from hexafluoropropylene may be included in the same as or larger amount than that of the structural unit derived from a carboxyl-containing monomer. In an implementation, the copolymer may include the structural unit derived from hexafluoropropylene and the structural unit derived from a carboxyl-containing monomer, e.g., in a weight ratio of about 1:1 to about 4:1 or greater than 1:1 to about 4:1. When the structural unit derived from hexafluoropropylene and the structural unit derived from a carboxyl-containing monomer are included within the ratio, adherence of the heat-resistant porous layer 30 to the electrode and permeability may be simultaneously satisfactory.

In an implementation, the copolymer may have a weight average molecular weight ranging from about 800,000 g/mol to about 1,500,000 g/mol, e.g., about 800,000 g/mol to about 1,200,000 g/mol. The copolymer having a weight average molecular weight within the range may secure adherence of the heat-resistant porous layer 30.

In an implementation, the filler may be included in an amount of greater than or equal to about 50 wt %, based on the total weight of the copolymer and the filler. Within the range, the filler may help secure heat resistance and thus help prevent deformation of a separator as a temperature is increased. In an implementation, the filler may be included in an amount of about 50 to about 99 wt %, e.g., about 60 to about 95 wt % or about 70 to about 90 wt %.

In an implementation, the binder may include one or more kinds of binder other than the copolymer.

The binder may further include, e.g., a cross-linkable binder having a cross-linking structure.

The cross-linkable binder may be obtained from a monomer, an oligomer, and/or a polymer having a curable functional group capable of reacting with heat and/or light, e.g., a multi-functional monomer, a multi-functional oligomer, and/or a multi-functional polymer having at least two curable functional groups. For example, the cross-linkable binder may have about 2 to about 30 curable functional groups, about 2 to about 20 curable functional groups, or about 3 to about 15 curable functional groups.

The curable functional group may be a vinyl group, a (meth)acrylate group, an epoxy group, an oxetane group, an ether group, a cyanate group, an isocyanate group, a hydroxy group, a carboxyl group, a thiol group, an amino group, an alkoxy group, or a combination thereof.

For example, the cross-linkable binder may be obtained from a monomer, an oligomer and/or a polymer including at least two vinyl groups, (meth)acrylate groups, epoxy groups, oxetane groups, ether groups, cyanate groups, isocyanate groups, hydroxy groups, carboxyl groups, thiol group, amino groups, alkoxy groups, or a combination thereof.

For example, the cross-linkable binder may be obtained from a monomer, an oligomer, and/or a polymer including at least two (meth)acrylate groups, for example ethylene glycol di(meth)acrylate, propylene glycol di(meth)acrylate, polyethylene glycol di(meth)acrylate, polypropylene glycol di(meth)acrylate, butanediol di(meth)acrylate, hexamethylene glycol di(meth)acrylate, trimethylolpropane tri(meth)acrylate, glycerine tri(meth)acrylate, pentaerythritol tetra(meth)acrylate, diglycerine hexa(meth)acrylate, or a combination thereof.

For example, the cross-linkable binder may be obtained from a monomer, an oligomer and/or a polymer including at least two epoxy groups, for example bisphenol A diglycidyl ether, bisphenol F diglycidyl ether, hexahydrophthalic acid glycidyl ester, or a combination thereof.

For example, the cross-linkable binder may be obtained from a monomer, an oligomer and/or a polymer including at least two isocyanate groups, for example diphenylmethane diisocyanate, 1,6-hexamethylene diisocyanate, 2,2,4 2, 2, and 4-trimethylhexamethylene diisocyanate, phenylene diisocyanate, 4,4′-dicyclohexylmethane diisocyanate, 3,3′-dimethyldiphenyl-4,4′-diisocyanate, xylene diisocyanate, naphthalene diisocyanate, 1,4-cyclohexyl diisocyanate, or a combination thereof.

The cross-linkable binder may have a weight average molecular weight of about 50 g/mol to about 80,000 g/mol, e.g., about 100 g/mol to about 60,000 g/mol. When the cross-linkable binder has a weight average molecular weight within the range, heat resistance may be secured.

In an implementation, the binder may further include, e.g., a non-cross-linkable binder.

The non-cross-linkable binder may include, e.g., a vinylidenefluoride-based polymer such as a polyvinylidene fluoride (PVdF) homopolymer, a polyvinylidene fluoride-hexafluoropropylene (PVdF-HFP) copolymer and the like, polymethylmethacrylate, polyacrylonitrile, polyvinylpyrrolidone, polyvinylacetate, polyethylene-vinylacetate copolymer, polyethyleneoxide, cellulose acetate, cellulose acetate butyrate, cellulose acetate propionate, cyanoethyl pullulan, cyanoethylpolyvinyl alcohol, cyanoethyl cellulose, cyanoethylsucrose, pullulan, carboxylmethyl cellulose, an acrylonitrile-styrene-butadiene copolymer, or a combination thereof.

In an implementation, the heat-resistant porous layer 30 may have a thickness of about 0.01 μm to about 20 μm, e.g., about 1 μm to about 10 μm or about 1 μm to about 5 μm.

The separator for a rechargeable battery may be, e.g., formed by coating a composition for a heat-resistant porous layer on one surface or both surfaces of the porous substrate 20 and then, drying it.

In an implementation, the composition for a heat-resistant porous layer may include the binder, the filler, and a solvent. The solvent may be a suitable solvent that dissolves or disperses the binder and the filler. In an implementation, the solvent may be a low boiling point solvent having a boiling point of less than or equal to about 80° C., e.g., acetone, methylethylketone, ethylisobutylketone, tetrahydrofuran, dimethylformaldehyde, cyclohexane or a mixed solvent thereof.

The coating may include, e.g., spin coating, dip coating, bar coating, die coating, slit coating, roll coating, inkjet printing, and the like.

The drying may be, e.g., performed through drying with warm air, hot air, or low humid air, vacuum-drying, or radiation of a far-infrared ray, an electron beam, or the like. The drying may be, e.g., performed at about 25° C. to about 120° C.

The separator for a rechargeable battery may be made using a method of lamination, coextrusion, or the like in addition to the method.

Hereinafter, a rechargeable lithium battery including the separator for a rechargeable battery is described.

A rechargeable lithium battery may be classified into a lithium ion battery, a lithium ion polymer battery, and a lithium polymer battery depending on kinds of a separator and an electrolyte. It also may be classified to be cylindrical, prismatic, coin-type, pouch-type, and the like depending on shape. In addition, it may be bulk type and thin film type depending on sizes. Structures and manufacturing methods for lithium ion batteries pertaining to this disclosure are well known in the art.

Herein, as an example of a rechargeable lithium battery, a prismatic rechargeable lithium battery is for example described.

FIG. 2 illustrates a perspective view of a rechargeable lithium battery according to an embodiment.

Referring to FIG. 2, a rechargeable lithium battery 100 according to one embodiment may include an electrode assembly 60 (e.g., manufactured by interposing a separator 10 between a positive electrode 40 and a negative electrode 50 and winding or folding them), and a case 70 housing the electrode assembly 60.

In an implementation, the electrode assembly 60 may have, e.g., a jelly-roll shape formed by winding the positive electrode 40, the negative electrode 50, and the separator 10 interposed therebetween.

The positive electrode 40, the negative electrode 50, and the separator 10 may be impregnated in an electrolyte solution.

The positive electrode 40 may include a positive current collector and a positive active material layer formed on the positive current collector. The positive active material layer may include, e.g., a positive active material, a binder, and optionally a conductive material.

The positive current collector may include, e.g., aluminum (Al), nickel (Ni), or the like.

The positive active material may use a compound being capable of intercalating and deintercalating lithium. For example, at least one of a composite oxide or a composite phosphate of a metal selected from cobalt, manganese, nickel, aluminum, iron, or a combination thereof and lithium may be used. In an implementation, the positive active material may use lithium cobalt oxide, lithium nickel oxide, lithium manganese oxide, lithium nickel cobalt manganese oxide, lithium nickel cobalt aluminum oxide, lithium iron phosphate, or a combination thereof.

The binder may help improve binding properties of positive active material particles with one another and with a current collector, and examples may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like. These may be used singularly or as a mixture of two or more.

The conductive material may help improve conductivity of an electrode. Examples thereof may include natural graphite, artificial graphite, carbon black, a carbon fiber, a metal powder, a metal fiber, and the like. These may be used singularly or as a mixture of two or more. The metal powder and the metal fiber may use a metal of copper, nickel, aluminum, silver, and the like.

The negative electrode 50 may include a negative current collector and a negative active material layer formed on the negative current collector.

The negative current collector may include, e.g., copper (Cu), gold (Au), nickel (Ni), a copper alloy, or the like.

The negative active material layer may include a negative active material, a binder, and optionally a conductive material.

The negative active material may be a material that reversibly intercalates/deintercalates lithium ions, a lithium metal, a lithium metal alloy, a material being capable of doping and dedoping lithium, a transition metal oxide, or a combination thereof.

The material that reversibly intercalates/deintercalates lithium ions may be a carbon material which is a suitable carbon-based negative active material, and examples thereof may include crystalline carbon, amorphous carbon, or a combination thereof.

Examples of the crystalline carbon may include graphite such as amorphous, sheet-shape, flake, spherical shape or fiber-shaped natural graphite or artificial graphite. Examples of the amorphous carbon may include soft carbon or hard carbon, a mesophase pitch carbonized product, fired coke, and the like. The lithium metal alloy may include an alloy of lithium and a metal selected from Na, K, Rb, Cs, Fr, Be, Mg, Ca, Sr, Si, Sb, Pb, In, Zn, Ba, Ra, Ge, Al, and Sn. The material being capable of doping and dedoping lithium may include Si, SiOₓ (0<x<2), a Si—C composite, a Si—Y′ alloy, Sn, SnO₂, a Sn—C composite, a Sn—Y′ alloy, and the like, and at least one of these may be mixed with SiO₂. Examples of the element Y′ may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof. The transition metal oxide may include vanadium oxide, lithium vanadium oxide, or the like.

The binder and the conductive material used in the negative electrode may be the same as the binder and conductive material of the positive electrode.

The positive electrode 40 and the negative electrode 50 may be manufactured by mixing each active material composition including each active material and a binder, and optionally a conductive material in a solvent, and coating the active material composition on each current collector. Herein, the solvent may include N-methylpyrrolidone or the like.

The separator 10 may be the same as described above.

The electrolyte solution may include an organic solvent and a lithium salt.

The organic solvent may serve as a medium for transmitting ions taking part in the electrochemical reaction of a battery. Examples thereof may be selected from a carbonate-based solvent, an ester-based solvent, an ether-based solvent, a ketone-based solvent, an alcohol-based solvent, and an aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like, and the ester-based solvent may include methyl acetate, ethyl acetate, n-propyl acetate, 1,1-dimethylethyl acetate, methylpropionate, ethylpropionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, and the like, and the ketone-based solvent may include cyclohexanone, and the like. The alcohol-based solvent may include ethanol, isopropyl alcohol, and the like, and the aprotic solvent may include nitriles such as R—CN (R is a C2 to C20 linear or branched or cyclic hydrocarbon group, a double bond, an aromatic ring, or an ether bond), and the like, amides such as dimethyl formamide, dioxolanes such as 1,3-dioxolane, sulfolanes, and the like.

The organic solvent may be used singularly or in a mixture of two or more, and when the organic solvent is used in a mixture of two or more, the mixture ratio may be controlled in accordance with a desirable cell performance.

The lithium salt may be dissolved in an organic solvent, may supply lithium ions in a battery, may basically operate the rechargeable lithium battery, and may help improve lithium ion transportation between positive and negative electrodes therein. Examples of the lithium salt may include LiPF6, LiBF4, LiSbF6, LiAsF6, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y}+1SO₂) (x and y are natural numbers), LiCl, LiI, LiB(C₂O₄)₂, or a combination thereof.

The lithium salt may be used in a concentration ranging from about 0.1 M to about 2.0 M. When the lithium salt is included within the above concentration range, an electrolyte may have excellent performance and lithium ion mobility due to optimal electrolyte conductivity and viscosity.

The rechargeable lithium battery including the separator may be operated at a high voltage of greater than or equal to about 4.2 V, thus a rechargeable lithium battery having a high capacity may be accomplished without the deterioration of cycle life characteristics.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Synthesis of Copolymer

### Synthesis Example 1

1,295 g of deionized water, 0.75 g of methyl cellulose, 4.0 g of propylperoxydicarbonate, 467.8 g of vinylidenefluoride (VDF), 24.8 g of hexafluoropropylene (HFP), and 7.4 g of acrylic acid (AA) were put in a 1 L autoclave reactor and then, suspension-polymerized at 28° C. for 60 hours. After the polymerization, the suspended solution was deaerated, the obtained polymer slurry was dehydrated, washed, and dehydrated and then, dried in an 80° C. oven for 24 hours to obtain a copolymer.

A weight average molecular weight of the obtained copolymer was 1,120,000 g/mol.

### Synthesis Example 2

1295 g of deionized water, 0.75 g of methyl cellulose, 4.0 g of propylperoxydicarbonate, 457.6 g of vinylidenefluoride (VDF), 32.5 g of hexafluoropropylene (HFP), and 9.90 g of methacrylic acid (MAA) were put in a 1 L autoclave reactor and then, suspension-polymerized at 28° C. for 60 hours. After the polymerization, the suspended solution was deaerated, and the obtained polymer slurry was dehydrated, washed, and dehydrated and then, dried in an 80° C. oven for 24 hours to obtain a copolymer.

A weight average molecular weight of the copolymer was 1,140,000 g/mol.

### Synthesis Example 3

1295 g of deionized water, 0.75 g of methyl cellulose, 4.0 g of propylperoxydicarbonate, 465.0 g of vinylidenefluoride (VDF), 25.0 g of hexafluoropropylene (HFP), and 10.0 g of hydroxyethylacrylate (HEA) were put in a 1 L autoclave reactor and suspension-polymerized at 28° C. for 60 hours. After the polymerization, the suspended solution was deaerated, and the obtained polymer slurry was dehydrated, washed, and dehydrated and then, dried in an 80° C. oven for 24 hours to obtain a copolymer.

A weight average molecular weight of the copolymer was 1,115,000 g/mol.

### Synthesis Example 4

1295 g of deionized water, 0.75 g of methyl cellulose, 4.0 g of propylperoxydicarbonate, 455.0 g of vinylidenefluoride (VDF), 30.0 g of hexafluoropropylene (HFP), and 15.0 g of hydroxyethylmethacrylate (HEMA) were put in a 1 L autoclave reactor and suspension-polymerized at 28° C. for 60 hours. After the polymerization, the suspended solution was deaerated, and the obtained polymer slurry was dehydrated, washed, and dehydrated and then, dried in an 80° C. oven for 24 hours.

A weight average molecular weight of the copolymer was 1,110,000 g/mol.

### Synthesis Example 5

1295 g of deionized water, 0.75 g of methyl cellulose, 4.0 g of propylperoxydicarbonate, 465.0 g of vinylidenefluoride (VDF), 25.0 g of hexafluoropropylene (HFP), and 10.0 g of hydroxypropylacrylate (HPA) were put in a 1 L autoclave reactor and then, suspension-polymerized at 28° C. for 60 hours. After the polymerization, the suspended solution was deaerated, and the obtained polymer slurry was dehydrated, washed, and dehydrated and then, dried in an 80° C. oven for 24 hours to obtain a copolymer.

A weight average molecular weight of the copolymer was 1,105,000 g/mol.

### Synthesis Example 6

1295 g of deionized water, 0.75 g of methyl cellulose, 4.0 g of propylperoxydicarbonate, 450.0 g of vinylidenefluoride (VDF), 35.0 g of hexafluoropropylene (HFP), and 15.0 g of hydroxybutylacrylate (HBA) were put in a 1 L autoclave reactor and then, suspension-polymerized at 28° C. for 60 hours. After the polymerization, the suspended solution was deaerated, and the obtained polymer slurry was dehydrated, washed, and dehydrated and then, dried in an 80° C. oven for 24 hours to obtain a copolymer.

A weight average molecular weight of the copolymer was 1,103,000 g/mol.

### Comparative Synthesis Example 1

A polyvinylidene fluoride polymer (KF-9300, Kureha) was used.

### Comparative Synthesis Example 2

1295 g of deionized water, 0.75 g of methyl cellulose, 4.0 g of propylperoxydicarbonate, 445.0 g of vinylidenefluoride (VDF), 15.0 g of hexafluoropropylene (HFP), and 40 g of acrylic acid (AA) were put in a 1 L autoclave reactor and then, suspension-polymerized at 28° C. for 60 hours. After the polymerization, the suspended solution was deaerated, and the obtained polymer slurry was dehydrated, washed, and dehydrated and then, dried in an 80° C. oven for 24 hours to obtain a copolymer.

A weight average molecular weight of the copolymer was about 1,000,000 g/mol.

### Comparative Synthesis Example 3

1295 g of deionized water, 0.75 g of methyl cellulose, 4.0 g of propylperoxydicarbonate, 437.5 g of vinylidenefluoride (VDF), 12.0 g of hexafluoropropylene (HFP), and 0.5 g of acrylic acid (AA) were put in a 1 L autoclave reactor and then, suspension-polymerized at 28° C. for 60 hours. When the polymerization was complete, the suspended solution was deaerated, and the obtained polymer slurry wad dehydrated, washed, and dehydrated and then, dried in an 80° C. oven for 24 hours to obtain a copolymer.

A weight average molecular weight of the copolymer was about 800,000 g/mol.

Evaluation 1

A composition ratio, a melting point (Tm), and inherent viscosity (η) of the copolymers of Synthesis Examples 1 to 6 and Comparative Synthesis Examples 1 to 3 were determined and are shown in Table 1, below.

The melting point was measured in a differential scanning calorimeter (DSC), and the inherent viscosity was measured by measuring capillary viscosity with an Ubbelohde viscometer.

TABLE 1

| | | Composition | Tm | η |
|---|---|---|---|---|
| | Copolymer | ratio | (° C.) | (dl/g) |
| Synthesis Example 1 | VDF/HFP/AA | 93.5/5/1.5 | 165 | 3.43 |
| Synthesis Example 2 | VDF/HFP/MAA | 91.5/6.5/2 | 166 | 3.41 |
| Synthesis Example 3 | VDF/HFP/HEA | 93/5/2 | 164 | 3.50 |
| Synthesis Example 4 | VDF/HFP/HEAM | 91/6/3 | 162 | 3.51 |
| Synthesis Example 5 | VDF/HFP/HPA | 93/5/2 | 173 | 3.50 |
| Synthesis Example 6 | VDF/HFP/HBA | 90/7/3 | 163 | 3.47 |
| Comparative Synthesis | PVDF | — | 175 | 3.50 |
| Example 1 | | | | |
| Comparative Synthesis | VDF/HFP/AA | 89/3/8 | 163 | 3.44 |
| Example 2 | | | | |
| Comparative Synthesis | VDF/HFP/AA | 87.5/12/0.5 | 153 | 3.21 |
| Example 3 | | | | |

Evaluation 2

Solubility of the copolymers according to the Synthesis Examples and Comparative Synthesis Examples in a low boiling point solvent was evaluated.

The solubility in a low boiling point solvent was evaluated by mixing each copolymer of Synthesis Examples and Comparative Synthesis Examples with acetone in a concentration of 10 wt % and stirring the mixture at 45° C. for 120 minutes and then, examining whether non-dissolved gel was present or not.

The results are shown in Table 2.

TABLE 2

| | Presence of |
|---|---|
| | non-dissolved gel |
| Synthesis Example 1 | X |
| Synthesis Example 2 | X |
| Synthesis Example 3 | X |
| Synthesis Example 4 | X |
| Synthesis Example 5 | X |
| Synthesis Example 6 | X |
| Comparative Synthesis | ◯ |
| Example 1 | |
| Comparative Synthesis | ◯ |
| Example 2 | |
| Comparative Synthesis | ◯ |
| Example 3 | |

Referring to Table 2, the copolymers of the Synthesis Examples were well dissolved in acetone, a low boiling point solvent and thus were not present as a non-dissolved gel. The copolymers of the Comparative Synthesis Examples were present in a large amount as a non-dissolved gel. Accordingly, the copolymers of the Synthesis Examples had high solubility in acetone.

### Manufacture of Separator

### Example 1-1

The copolymer of Synthesis Example 1 was mixed with alumina (LS235A, KBM-503) and acetone to prepare a composition. The composition included the copolymer and the alumina in a weight ratio of 1:2 and included 10 wt % of a solid and 90 wt % of the acetone.

The composition was dip-coated on a 7 μm-thick polyethylene substrate (SK Innovation Co.) and dried at 80° C. for 20 seconds to manufacture a separator.

### Example 1-2

A separator was manufactured according to the same method as Example 1-1 except for including the copolymer and the alumina in a weight ratio of 1:4.

### Example 1-3

A separator was manufactured according to the same method as Example 1-1 except for including the copolymer and the alumina in a weight ratio of 1:5.

### Example 1-4

A separator was manufactured according to the same method as Example 1-1 except for including the copolymer and the alumina in a weight ratio of 1:7.

### Example 2-1

A separator was manufactured according to the same method as Example 1-1 except for using the copolymer of Synthesis Example 2 instead of the copolymer of Synthesis Example 1.

### Example 2-2

A separator was manufactured according to the same method as Example 2-1 except for including the copolymer and the alumina in a weight ratio of 1:4.

### Example 2-3

A separator was manufactured according to the same method as Example 2-1 except for including the copolymer and the alumina in a weight ratio of 1:5.

### Example 2-4

A separator was manufactured according to the same method as Example 2-1 except for including the copolymer and the alumina in a weight ratio of 1:7.

### Example 3-1

A separator was manufactured according to the same method as Example 1-1 except for using the copolymer of Synthesis Example 3 instead of the copolymer of Synthesis Example 1.

### Example 3-2

A separator was manufactured according to the same method as Example 3-1 except for including the copolymer and the alumina in a weight ratio of 1:4.

### Example 3-3

A separator was manufactured according to the same method as Example 3-1 except for including the copolymer and the alumina in a weight ratio of 1:5.

### Example 3-4

A separator was manufactured according to the same method as Example 3-1 except for including the copolymer and the alumina in a weight ratio of 1:7.

### Example 4-1

A separator was manufactured according to the same method as Example 1-1 except for using the copolymer of Synthesis Example 4 instead of the copolymer of Synthesis Example 1.

### Example 4-2

A separator was manufactured according to the same method as Example 4-1 except for including the copolymer and the alumina in a weight ratio of 1:4.

### Example 4-3

A separator was manufactured according to the same method as Example 4-1 except for including the copolymer and the alumina in a weight ratio of 1:5.

### Example 4-4

A separator was manufactured according to the same method as Example 4-1 except for including the copolymer and the alumina in a weight ratio of 1:7.

### Example 5-1

A separator was manufactured according to the same method as Example 1-1 except for using the copolymer of Synthesis Example 5 instead of the copolymer of Synthesis Example 1.

### Example 5-2

A separator was manufactured according to the same method as Example 5-1 except for including the copolymer and the alumina in a weight ratio of 1:4.

### Example 5-3

A separator was manufactured according to the same method as Example 5-1 except for including the copolymer and the alumina in a weight ratio of 1:5.

### Example 5-4

A separator was manufactured according to the same method as Example 5-1 except for including the copolymer and the alumina in a weight ratio of 1:7.

### Example 6-1

A separator was manufactured according to the same method as Example 1-1 except for using the copolymer of Synthesis Example 6 instead of the copolymer of Synthesis Example 1.

### Example 6-2

A separator was manufactured according to the same method as Example 6-1 except for including the copolymer and the alumina in a weight ratio of 1:4.

### Example 6-3

A separator was manufactured according to the same method as Example 6-1 except for including the copolymer and the alumina in a weight ratio of 1:5.

### Example 6-4

A separator was manufactured according to the same method as Example 6-1 except for including the copolymer and the alumina in a weight ratio of 1:7.

### Comparative Example 1-1

A separator was manufactured according to the same method as Example 1-1 except for using the polymer of Comparative Synthesis Example 1 instead of the copolymer of Synthesis Example 1.

### Comparative Example 1-2

A separator was manufactured according to the same method as Comparative Example 1-1 except for including the polymer and the alumina in a weight ratio of 1:4.

### Comparative Example 1-3

A separator was manufactured according to the same method as Comparative Example 1-1 except for including the polymer and the alumina in a weight ratio of 1:5.

### Comparative Example 1-4

A separator was manufactured according to the same method as Comparative Example 1-1 except for including the polymer and the alumina in a weight ratio of 1:7.

### Comparative Example 2-1

A separator was manufactured according to the same method as Example 1-1 except for using the copolymer of Comparative Synthesis Example 2 instead of the copolymer of Synthesis Example 1.

### Comparative Example 3-1

A separator was manufactured according to the same method as Example 1-1 except for using the copolymer of Comparative Synthesis Example 3 instead of the copolymer of Synthesis Example 1.

Evaluation 3

Permeability of the separators according to Examples and Comparative Examples was evaluated.

The permeability was evaluated in the following method.

Ten samples having a size capable of containing a disk with a diameter of 1 inch were cut from each separator, and how long it took for each sample to pass 100 cc of air was measured by using a permeability meter (Asahi Seico Co., Ltd.). The time was respectively measured five times and then averaged. As the permeability was larger, the air was passed for a shorter time, while as the permeability was smaller, the air was passed for a longer time. The results are shown in Table 3, below.

Evaluation 4

A rechargeable lithium battery cell was manufactured in the following method and then, charged and discharged, and an adhesion force, a thickness variation ratio, and a capacity retention of each separator were evaluated.

LiCoO₂, polyvinylidene fluoride, and carbon black in a weight ratio of 96:2:2 were added to an N-methylpyrrolidone (NMP) solvent to prepare a slurry. The slurry was coated on an aluminum (Al) thin film and then, dried and compressed to manufacture a positive electrode.

In addition, graphite, polyvinylidene fluoride, and carbon black in a weight ratio of 98:1:1 were added to an N-methylpyrrolidone (NMP) solvent to prepare a slurry. The slurry was coated on a copper foil (a Cu foil) and then, dried and compressed to manufacture a negative electrode.

An electrolyte solution was prepared by mixing ethylene carbonate (EC), ethylmethyl carbonate (EMC), and diethyl carbonate (DEC) in a volume ratio of 3:5:2 and forming a 1.15 M LiPF₆ solution in the mixed solvent.

Each separator of the Examples and Comparative Examples was interposed between the positive and negative electrodes to prepare a jelly roll-shaped electrode assembly. Subsequently, the electrode assembly was fixed in a case, the electrolyte solution was injected thereinto, and the case was sealed to respectively manufacture rechargeable lithium battery cells.

(1) Adhesion Force

The rechargeable lithium battery cells were processed through formation, charged and discharged under a 0.2 C charge, 0.2 C discharge, and 0.5 C charge condition, and then, disassembled into positive electrodes, separators, and negative electrodes. Subsequently, the areas of the positive and negative electrodes transferred on the surface of the separators were measured to evaluate adhesion forces of the separators to the electrodes. The adhesion forces of the separator to the electrodes were evaluated as a percentage of the area transferred to the separator based on the entire area of the electrodes. The results are shown in Table 3.

(2) Thickness Variation Ratio

The rechargeable lithium battery cells were respectively charged and discharged 500 times under a 0.7 C condition and disassembled into the positive electrodes, the separators, and the negative electrodes. Subsequently, thickness of each separator was measured and compared with its initial thickness before the charge and discharge to obtain a thickness variation ratio as a percentage. The results are shown in Table 3.

(3) Capacity Retention

The rechargeable lithium battery cells were charged and discharged 500 times under a 0.7 C condition, and their capacity retentions were evaluated.

The results are shown in Table 3.

TABLE 3

| | Binder: | | | Thickness | Capacity |
|---|---|---|---|---|---|
| | alumina | Permeability | Adhesion | variation | retention |
| | (wt:wt) | (sec/100 cc) | force (%) | ratio (%) | (%) |
| Example 1-1 | 1:2 | 230 | 100 | 5.7 | 88.3 |
| Example 1-2 | 1:4 | 223 | 92 | 6.0 | 90.2 |
| Example 1-3 | 1:5 | 210 | 80 | 6.5 | 92.3 |
| Example 1-4 | 1:7 | 198 | 60 | 7.2 | 93.5 |
| Example 2-1 | 1:2 | 228 | 100 | 5.6 | 87.1 |
| Example 2-2 | 1:4 | 221 | 95 | 6.1 | 89.2 |
| Example 2-3 | 1:5 | 208 | 85 | 6.4 | 90.5 |
| Example 2-4 | 1:7 | 195 | 61 | 7.0 | 92.4 |
| Example 3-1 | 1:2 | 241 | 100 | 5.4 | 86.7 |
| Example 3-2 | 1:4 | 233 | 93 | 6.1 | 88.5 |
| Example 3-3 | 1:5 | 226 | 83 | 6.7 | 91.3 |
| Example 3-4 | 1:7 | 210 | 59 | 7.1 | 92.1 |
| Example 4-1 | 1:2 | 231 | 100 | 5.1 | 86.9 |
| Example 4-2 | 1:4 | 224 | 95 | 5.8 | 89.8 |
| Example 4-3 | 1:5 | 215 | 83 | 6.1 | 91.1 |
| Example 4-4 | 1:7 | 200 | 63 | 6.8 | 92.5 |
| Example 5-1 | 1:2 | 226 | 100 | 5.5 | 84.2 |
| Example 5-2 | 1:4 | 218 | 96 | 6.4 | 88.3 |
| Example 5-3 | 1:5 | 200 | 86 | 6.7 | 89.9 |
| Example 5-4 | 1:7 | 197 | 66 | 7.2 | 91.5 |
| Example 6-1 | 1:2 | 233 | 100 | 5.5 | 87.2 |
| Example 6-2 | 1:4 | 226 | 92 | 6.0 | 90.5 |
| Example 6-3 | 1:5 | 210 | 88 | 6.4 | 91.3 |
| Example 6-4 | 1:7 | 201 | 60 | 6.9 | 92.1 |
| Comparative | 1:2 | 333 | 40 | 7.1 | 73.3 |
| Example 1-1 | | | | | |
| Comparative | 1:4 | 310 | 25 | 7.9 | 76.5 |
| Example 1-2 | | | | | |
| Comparative | 1:5 | 289 | 10 | 9.5 | 78.7 |
| Example 1-3 | | | | | |
| Comparative | 1:7 | 270 | 0 | 12.3 | 81.0 |
| Example 1-4 | | | | | |
| Comparative | 1:2 | 350 | 17 | 17.3 | 75.2 |
| Example 2-1 | | | | | |
| Comparative | 1:2 | 572 | 15 | 22.5 | 77.5 |
| Example 3-1 | | | | | |

*Permeability of a polyethylene substrate: 150 seconds

Referring to Table 3, the separators of the Examples exhibited excellent permeability, compared with the separators of the Comparative Examples. The rechargeable lithium battery cells manufactured by applying the separators of the Examples exhibited satisfactory adhesion forces, thickness variation ratios, and capacity retention after the charge and discharge, compared with the rechargeable lithium battery cells manufactured by applying the separators of the Comparative Examples.

By way of summation and review, a separator may contribute to excellent battery stability (in the face of, e.g., exothermicity), as a battery tends to be lighter and down-sized while having high capacity as a power source having high power/large capacity for the electric vehicle. Accordingly, a separator may include a heat-resistant porous layer, and the heat-resistant porous layer may exhibit good adherence and durability.

The embodiments may provide a separator for a rechargeable battery having improved adherence and durability.

Battery characteristics of a rechargeable lithium battery may be improved by including a separator having improved adherence and durability.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A separator for a rechargeable battery, the separator comprising:
a porous substrate; and
a heat-resistant porous layer on at least one surface of the porous substrate,
wherein:
the heat-resistant porous layer includes a filler and a copolymer including a structural unit of vinylidenefluoride, a structural unit of hexafluoropropylene, and a structural unit of a carboxyl-containing monomer,
the structural unit of hexafluoropropylene is present in an amount of about 4 wt % to about 10 wt %, based on a total weight of the copolymer, and
the structural unit of a carboxyl-containing monomer is present in an amount of about 1 wt % to about 7 wt %, based on the total weight of the copolymer.

2. The separator as claimed in claim 1, wherein the copolymer includes the structural unit of hexafluoropropylene and the structural unit of the carboxyl-containing monomer in a weight ratio of about 1:1 to about 4:1.

3. The separator as claimed in claim 1, wherein the carboxyl-containing monomer includes a substituted or unsubstituted (meth)acrylic acid, a substituted or unsubstituted (meth)acryloyloxy acetic acid, a substituted or unsubstituted (meth)acryloyloxy alkyl acid, a substituted or unsubstituted itaconic acid, a substituted or unsubstituted maleic acid, a substituted or unsubstituted maleic anhydride, or a combination thereof.

4. The separator as claimed in claim 1, wherein the copolymer has a weight average molecular weight of about 800,000 g/mol to about 1,500,000 g/mol.

5. The separator as claimed in claim 1, wherein the filler is included in an amount of about 50 wt % to about 99 wt %, based on a total weight of the copolymer and the filler.

6. The separator as claimed in claim 5, wherein the filler includes Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, or a combination thereof.

7. The separator as claimed in claim 1, wherein the porous substrate includes a polyolefin.

8. The separator as claimed in claim 1, wherein the porous substrate is in the form of a single layer or two or more layers.

9. A rechargeable lithium battery, comprising
a positive electrode,
a negative electrode, and
the separator as claimed in claim 1 between the positive electrode and the negative electrode.
